(19) United States
(12) Patent Application Publication
(10) Pub. No.: US 2012/0065836 A1
(43) Pub. Date: Mar. 15, 2012

(54) Method and apparatus for fault diagnosis in a rail vehicle

(76) Inventors: Björn Heinrichs, Willich (DE); Jörg Jungmann, Tonisvorst (DE); Norman Matthias, Erkelenz (DE); Norbert Werkmeister, Kempen (DE)

(21) Appl. No.: 12/880,203

(22) Filed: Sep. 13, 2010

(51) Int. Cl. G06F 19/00

(52) U.S. Cl. 701/33.4; 701/29.7

(57) ABSTRACT

An apparatus and a method of diagnosis of a fault in a component of a rail vehicle are provided. A fault which has occurred in a component of the rail vehicle is detected by a diagnosis device, and associated fault data is stored. Further, data which originates from an acoustic and/or optical recording device in the rail vehicle and which contains information relating to the fault is stored and is included in the diagnosis of the fault.

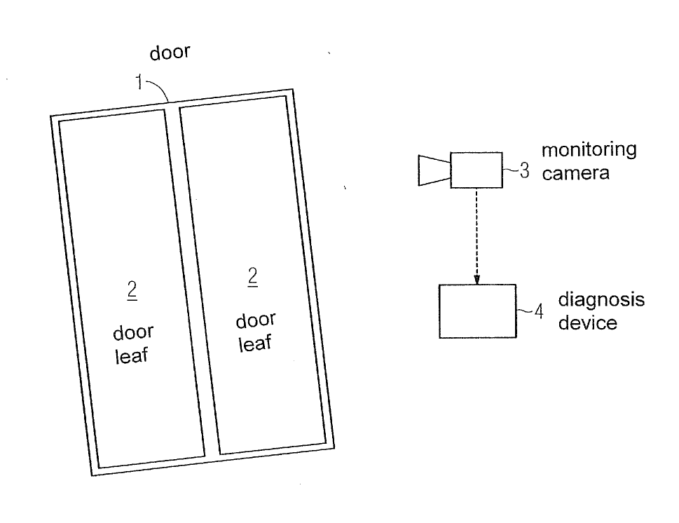

### FIELD OF INVENTION

The invention relates to a method and to an apparatus for diagnosis of a fault in a component in a rail vehicle.

### SUMMARY OF INVENTION

Known apparatuses for fault diagnosis are designed such that a diagnosis device gathers system data, which is associated with a fault that has occurred, and provides this for subsequent analysis.

In this case, it is possible for the available diagnosis data not to be adequate in the case of complicated fault situations in complex systems. In fact, information is required which goes beyond the system data provided by the diagnosis device.

By way of example, in the case of complicated fault situations, attempts are made to simulate the faults which have occurred, to observe them, to record the change in the diagnosis data, and to draw conclusions relating to the fault cause therefrom.

It is therefore frequently considered to be necessary for fault analysis for specialist personnel to visually inspect the fault in situ. Inter alia, this involves a considerable amount of traveling and therefore a considerable amount of time, in order, for example, to allow a faulty rail vehicle to be examined by the specialist at its point of use.

An object of the claimed invention is to provide a method and an apparatus for diagnosis of a fault in a component in a rail vehicle, in which the fault analysis can be carried out with less effort.

With regard to the method, this object is achieved by a method for diagnosis of a fault in a component in a rail vehicle, wherein a fault which has occurred in a component in the rail vehicle is detected by a diagnosis device, and associated fault data is stored, and data which originates from an acoustic and/or optical recording device in the rail vehicle and which contains information relating to the fault is stored and is included in the diagnosis of the fault.

In this case, it is of major importance that data which originates from the acoustic and/or optical recording device in the rail vehicle is included in the diagnosis of the fault. This makes it possible to carry out a more detailed fault analysis even at a location a long distance away from the faulty rail vehicle, by collation of the system data provided by the diagnosis device and the acoustic and/or optical data from the recording device in the rail vehicle.

With regard to the method, it is advantageous for one of the monitoring cameras in the rail vehicle to be used as the recording device. This has the advantage that no additional hardware retrofitting of the rail vehicle is required to carry out the method.

However, alternatively, it is also possible to use a camera which is installed specifically for the component as the recording device. A door area of a rail vehicle may be mentioned as an example. In order to optically detect faults for example in the door or a sliding step, a camera can be installed at a suitable point in the interior of the rail vehicle, and the image data produced by this camera can also be used for fault diagnosis in the event of a fault.

In this case, it is advantageous if image data which comprises at least one individual image of the faulty component is used as the data which contains information relating to the fault. In the example explained above, this would be the door or the sliding step.

It is also possible for the image data to be formed by a video sequence, as a result of which, in particular, it is possible to comprehend dynamic processes.

The method can provide that the data which contains information relating to the fault is included manually in the diagnosis of the fault. This means that an attempt is made manually to associate the fault data gathered by the diagnosis device with, for example, image data which is supplied by the recording device. For example, system data is provided with a time stamp. If image data associated with this point or period in time is available in a suitably positioned recording device, its data is included in the fault diagnosis.

In the situation in which a fault which has occurred is reproduced, it is possible, for example, for a suitably positioned monitoring camera to gather and to store image data relating to the faulty component during the reproduction of the fault.

Alternatively, it is also possible for the data which contains information relating to the fault to be included automatically in the diagnosis of the fault. This is possible in particularly when monitoring cameras in rail vehicles are used to supply the image data relating to the faulty component. Typically, monitoring cameras run continuously and their data is stored, with time details being added. In situations such as this, it is possible to use a central computer to automatically associate the system data, with the time stamp attached, from the diagnosis device and the image data from the monitoring camera.

### BRIEF DESCRIPTION OF THE DRAWINGS

Exemplary embodiments of the invention will be explained in more detail in the following text with reference to the drawing. The single figure shows a schematic illustration of an apparatus for diagnosis of a fault in a rail vehicle, in combination with a rail vehicle door.

### DETAILED DESCRIPTION OF INVENTION

As an example of a faulty component in a rail vehicle, a door 1 with door leaves 2 is shown on the left in the figure. A monitoring camera 3 is located at the top on the right in the figure, as is frequently already preinstalled nowadays in rail vehicles, but which has until now been used exclusively for monitoring purposes.

Furthermore, at the bottom on the right, the figure shows a diagnosis device 4 which monitors components in the rail vehicle in a conventional manner, in particular also the vehicle door 1. In the event of a fault, the diagnosis device 4 gathers system data which is (can be) associated with, for example, a defect in the vehicle door 1.

The overall apparatus for diagnosis of a fault in the vehicle door 1 therefore comprises both the monitoring camera 3 and the diagnosis device 4.

In a first exemplary embodiment, the monitoring camera 3 or else, alternatively, a camera which is installed specifically for the vehicle door 1, on the one hand, and the diagnosis device 4 on the other hand, are connected for signaling purposes. In the situation in which the diagnosis device 4 identifies a fault in the vehicle door 1, measures are taken such that image data which is obtained by the monitoring camera 3 when the fault occurs is called up, such that the fault diagnosis can be carried out both on the basis of the system data in the diagnosis device 4 and on the basis of the image data from the monitoring camera 3. For this purpose, the diagnosis device 4 may be in the form of a central computer, which also inserts the image data.

In addition, the monitoring camera 3 can also be equipped with an acoustic recording characteristic. In this case, acoustic data relating to the fault which has occurred in the vehicle door 1 is additionally taken into account.

In a second alternative, the image data from the monitoring camera 3 is obtained and stored physically separately by the diagnosis device 4. The image material produced by the monitoring camera 3 is manually examined on the basis of a time stamp relating to the fault data obtained by the diagnosis device 4, to determine whether it contains additional information relating to the detected fault in the vehicle door 1. If the result is positive, this additional information is also included in the fault analysis.

The image data obtained by the monitoring camera 3 may be individual images or else a video sequence. This depends on the type of fault detected in the vehicle door 1. In the case of faults which, for example, are associated with movement of the vehicle door 1, it is advantageous to analyze a video sequence.

A video sequence such as this or else individual images is or are advantageously stored in a memory, which is not illustrated here, as a result of which the data is available for subsequent fault analysis.

1.-14. (canceled)

15. A method of diagnosing a fault in a component of a rail vehicle, comprising:
detecting a fault which has occurred in a component of a rail vehicle by a diagnosis device;
storing fault data relating to the fault occurred in the component;
storing data originating from a recording device of the rail vehicle and containing information relating to the fault; and
diagnosing the fault occurred in the component, wherein the data originating from the recording device and containing information relating to the fault are included in the diagnosing.

16. The method as claimed in claim 15, wherein the recording device is an acoustic recording device.

17. The method as claimed in claim 15, wherein the recording device is an optical recording device.

18. The method as claimed in claim 15, wherein a monitoring camera already provided in the rail vehicle is used as the recording device.

19. The method as claimed in claim 15, wherein a camera specifically installed for the component is used as the recording device.

20. The method as claimed in claim 15, wherein image data including at least one individual image is used as the fault data with information relating to the fault.

21. The method as claimed in claim 20, wherein a video sequence is used as the image data.

22. The method as claimed in claim 15, wherein the fault data is included manually in the diagnosing the fault.

23. The method as claimed in claim 15, wherein the fault data is included automatically in the diagnosing the fault.

24. An apparatus for diagnosing a fault in a component of a rail vehicle, comprising:
a diagnosis device for detecting a fault which has occurred in a component of a rail vehicle;
a memory for storing fault data; and
a recording device for detecting and recording data containing information relating to the fault.

25. The apparatus as claimed in claim 24, wherein the recording device is an acoustic recording device.

26. The apparatus as claimed in claim 24, wherein the recording device is an optical recording device.

27. The apparatus as claimed in claim 24, wherein a monitoring camera already provided in the rail vehicle is used as the recording device.

28. The apparatus as claimed in claim 24, wherein a camera specifically installed for the component is used as the recording device.

29. The apparatus as claimed in claim 24, wherein the recording device provides image data as the fault data, the image data comprising at least one individual image of a faulty component.

30. The apparatus as claimed in claim 29, wherein the image data is a video sequence.

31. The apparatus as claimed in claim 24, wherein the diagnosis device and the recording device are separate devices.

32. The apparatus as claimed in claim 24, wherein the diagnosis device and the recording device include a signaling connection for diagnosing the fault.
